(19) United States
(12) Patent Application Publication
(10) Pub. No.: US 2020/0314493 A1
(43) Pub. Date: Oct. 1, 2020

(54) Systems and Methods for Scheduling Content

(71) Applicant: TD Ameritrade IP Company, Inc., Omaha, NE (US)

(72) Inventors: Tomas Jesus RUIZ, Chicago, IL (US); Sean Michael WYBOURN, Chicago, IL (US)

(21) Appl. No.: 16/371,057

(22) Filed: Mar. 31, 2019

(51) Int. Cl. H04N 21/458; H04N 21/262; H04N 21/2187

(52) U.S. Cl. CPC H04N 21/458; H04N 21/2187; H04N 21/26258

(57) ABSTRACT

A video content sequencing system includes at least one processor and a memory coupled to the at least one processor. The memory stores instructions that, upon execution, cause the at least one processor to, in response to input from an operator, identify a first video identifier of a first entry of the video catalog that corresponds to a requested video identifier of a schedule request. The input includes the schedule request including: (i) a request type, (ii) the requested video identifier, (iii) a requested date, and (iv) a requested time. The instructions further cause the at least one processor to schedule a first video associated with the first video identifier to be automatically displayed from a first source identifier associated with the first video identifier on a channel by adding the first video identifier to the schedule at the requested time on the requested date included in the schedule request.

### FIELD

The present disclosure relates to systems and methods for video broadcasts and more particularly to scheduling systems and methods for video broadcasts broadcasting.

### BACKGROUND

Traditionally, networks that broadcast live and pre-recorded content host the schedule on-site. Hosting schedules on-site requires an operator to be on-site to ensure that transitions between programming segments are properly executed. In addition to requiring the operator to be on-site, the schedule system is susceptible to power and utility outages because the schedule system is maintained locally. Further, manual transitions between segments is associated with staffing costs and mistakes caused by human frailties.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A video content sequencing system includes at least one processor and a memory coupled to the at least one processor. The memory stores a video catalog including a plurality of entries. Each entry of the plurality of entries includes: (i) a video identifier and (ii) a source identifier. The source identifier for each entry of the plurality of entries identifies at least one of: (i) a video database and (ii) a live stream device. The memory also stores a schedule including a plurality of scheduled video identifiers each of the plurality of scheduled video identifiers corresponding to a respective video identifier of a respective entry of the plurality of entries.

The memory further stores instructions that, upon execution, cause the at least one processor to, in response to input from an operator, identify a first video identifier of a first entry of the video catalog that corresponds to a requested video identifier of a schedule request. The input includes the schedule request. The schedule request includes: (i) a request type, (ii) the requested video identifier, (iii) a requested date, and (iv) a requested time. The instructions further cause the at least one processor to schedule a first video associated with the first video identifier to be automatically displayed from a first source identifier associated with the first video identifier on a channel by adding the first video identifier to the schedule at the requested time on the requested date included in the schedule request.

In other features, the video database stores a plurality of pre-recorded videos. Each pre-recorded video is associated with a pre-recorded video identifier. The plurality of entries of the video catalog include a corresponding entry for each pre-recorded video identifier. In other features, the plurality of entries of the video catalog are displayed to the operator on a display of a scheduling device. The input from the operator is a selection of the first video identifier. In other features, the instructions include, in response to the first source identifier identifying the live stream device, scheduling the live stream device to be broadcast on the channel at the requested time on the requested date included in the schedule request by adding a live stream device identifier to the schedule.

In other features, the instructions include scheduling the first video by generating a first scheduled video entry including: (i) a first scheduled video identifier, (ii) a first scheduled source identifier, (iii) a first scheduled date, and (iv) a first scheduled time to add to the schedule. In other features, the first scheduled video identifier is set to the first video identifier of the first entry of the video catalog and the first scheduled source identifier is set to the first source identifier of the first entry of the video catalog. In other features, the first scheduled date is set to the requested date of the scheduled request and the first scheduled time is set to the requested time of the scheduled request.

In other features, the instructions include, in response to scheduling the first video, identifying a previously scheduled video identifier of the schedule during a broadcast window of the first video identifier and, in response to identifying the previously scheduled video identifier, generating an overlapping alert. In other features, the instructions include displaying the overlapping alert on a display of a scheduling device. In other features, the instructions include, in response to the request type of the schedule request being an update schedule request, transmitting a set of scheduled video identifiers to a content network schedule of a content network.

In other features, the instructions include transmitting the set of scheduled video identifiers by selecting scheduled video identifiers scheduled to be broadcast between a present date and a present time and a cutoff date and a cutoff time. The instructions further include adding the selected scheduled video identifiers to the set of scheduled video identifiers and transmitting the set of scheduled video identifiers to the content network schedule of the content network. In other features, the set of scheduled video identifiers instructs the content network to transition to broadcast on the channel a scheduled video corresponding to a scheduled video identifier of the plurality of scheduled video identifiers on the content network schedule at a scheduled time on a scheduled date of the scheduled video.

A video content sequencing method includes, in response to input from an operator, identifying a first video identifier of a first entry of a video catalog that corresponds to a requested video identifier of a schedule request. The input includes the schedule request. The schedule request includes: (i) a request type, (ii) the requested video identifier, (iii) a requested date, and (iv) a requested time. The video catalog includes a plurality of entries. Each entry of the plurality of entries includes: (i) a video identifier and (ii) a source identifier. The source identifier for each entry of the plurality of entries identifies at least one of: (i) a video database and (ii) a live stream device. The method further includes scheduling a first video associated with the first video identifier to be automatically displayed from a first source identifier associated with the first video identifier on a channel by adding the first video identifier to a schedule at the requested time on the requested date included in the schedule request. The schedule includes a plurality of scheduled video identifiers each of the plurality of scheduled video identifiers corresponding to a respective video identifier of a respective entry of the plurality of entries.

In other features, the video database stores a plurality of pre-recorded videos. Each pre-recorded video is associated with a pre-recorded video identifier. The plurality of entries of the video catalog include a corresponding entry for each pre-recorded video identifier. In other features, the plurality of entries of the video catalog are displayed to the operator on a display of a scheduling device. The input from the operator is a selection of the first video identifier. In other features, the instructions further include, in response to the first source identifier identifying the live stream device, scheduling the live stream device to be broadcast on the channel at the requested time on the requested date included in the schedule request by adding a live stream device identifier to the schedule.

In other features, scheduling the first video includes generating a first scheduled video entry including: (i) a first scheduled video identifier, (ii) a first scheduled source identifier, (iii) a first scheduled date, and (iv) a first scheduled time to add to the schedule. In other features, the first scheduled video identifier is set to the first video identifier of the first entry of the video catalog. In other features, the first scheduled source identifier is set to the first source identifier of the first entry of the video catalog. In other features, the first scheduled date is set to the requested date of the scheduled request. In other features, the first scheduled time is set to the requested time of the scheduled request.

In other features, the instructions include, in response to scheduling the first video, identifying a previously scheduled video identifier of the schedule during a broadcast window of the first video identifier. In other features, the instructions include, in response to identifying the previously scheduled video identifier, generating an overlapping alert. In other features, the instructions include displaying the overlapping alert on a display of a scheduling device. In other features, the instructions include, in response to the request type of the schedule request being an update schedule request, transmitting a set of scheduled video identifiers to a content network schedule of a content network.

In other features, transmitting the set of scheduled video identifiers includes selecting scheduled video identifiers scheduled to be broadcast between a present date and a present time and a cutoff date and a cutoff time. In other features, the transmitting includes adding the selected scheduled video identifiers to the set of scheduled video identifiers and transmitting the set of scheduled video identifiers to the content network schedule of the content network. In other features, the set of scheduled video identifiers instructs the content network to transition to broadcast on the channel a scheduled video corresponding to a scheduled video identifier of the plurality of scheduled video identifiers on the content network schedule at a scheduled time on a scheduled date of the scheduled video.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a high-level example block diagram of a scheduling system and a network communication system according to the principles of the present disclosure.

FIGS. 2A-2C are graphical representations of example data structures used in scheduling according to the principles of the present disclosure.

FIG. 3 is a functional block diagram of an example scheduling system according to the principles of the present disclosure.

FIGS. 4-7 are representations of an example user interface of a scheduling system according to the principles of the present disclosure.

FIGS. 8A-8C are flowcharts depicting example processing of a schedule request within a scheduling system according to the principles of the present disclosure.

In the drawings, reference numbers may be reused to identify similar and/or identical elements.

### DETAILED DESCRIPTION

### Introduction

An interactive scheduling system according to the present disclosure manages a schedule composed of pre-recorded videos and/or live streams. The interactive scheduling system allows an operator to schedule automatic transitions between scheduled items, removing the need for an operator to perform any particular action at the time of the transition. Specifically, the operator can set a pre-recorded video to be broadcast at a particular time. Adjusting or scheduling the pre-recorded video to be broadcast at the particular time is graphically depicted using the interactive scheduling system. Additionally, the operator can use the interactive scheduling system to schedule a broadcast system to broadcast directly from a selected live streaming device during a predetermined time interval. For example, the operator can schedule an instruction to broadcast live from a digital video camera during the predetermined time interval.

The interactive scheduling system allows the operator to adjust some or all of the schedule on a local network and upload the schedule and/or any schedule changes to a remote content network scheduler. Once the schedule is uploaded, any local service interruptions, such as power loss or a loss of Internet access, will not prevent the remote content network scheduler from broadcasting the scheduled pre-recorded videos or live streams during each corresponding broadcasting time. Further, with backup power (such as a generator or uninterruptible power supplies), content can still be recorded for later broadcast.

In various implementations, if the network connectivity (which may be at least partially via the Internet) of a live stream location is interrupted, the live stream will itself be interrupted. There may be some amount of buffering to allow temporary interruptions to escape notice, but longer interruptions may trigger the playing of an error message or a specified piece of backup content. In some implementations, a longer interruption may trigger a switch to a different live stream location.

As indicated above, the schedule may be adjusted and supplemented prior to the broadcast of a particular pre-recorded video or a live stream. That is, the schedule can be set days, weeks, or months prior to the actual broadcast of the scheduled pre-recorded videos or live streams, eliminating the need for the operator to execute transitions on-site between pre-recorded videos and/or live streams.

### High-Level Network Communications

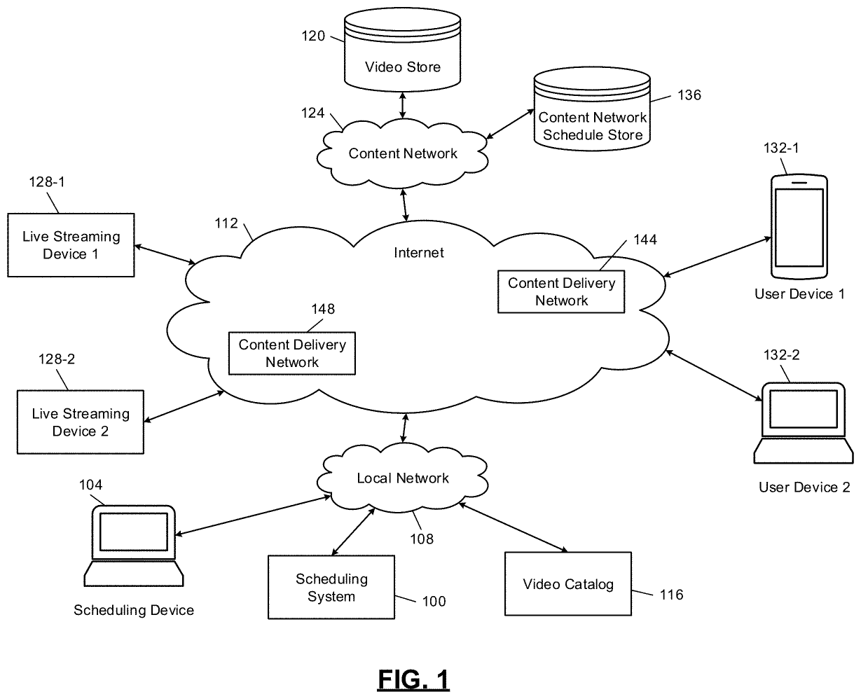

In FIG. 1, a scheduling system 100 is accessed by a scheduling device 104. For example, the scheduling device 104 may be a smartphone, tablet, desktop computer, or laptop computer, which accesses the scheduling system 100 using a web browser. The scheduling device 104 displays a scheduling user interface (UI) that an operator of the scheduling device 104 can interact with, adjust, and edit. In various implementations, the schedule is displayed on the scheduling device 104 as a calendar view. As shown and described below, the calendar view depicts what video content (whether pre-recorded or live stream) will be broadcast at what times.

The scheduling system 100 communicates with a local network 108. The local network 108 also communicates with the Internet 112 and a video catalog 116. In various implementations, the video catalog 116 is updated according to a video store 120. The video store 120 stores pre-recorded videos that can be selected through the scheduling system 100 to be broadcast. The video catalog 116 includes a list of available pre-recorded videos stored in the video store 120 to select for broadcast using the scheduling system 100. For security purposes, the scheduling device 104 may be required to be connected to a private LAN (in this case, the local network 108) to access the scheduling system 100. In various implementations, remote access to the scheduling system 100 may be provided to a remote scheduling device outside of the private LAN. Remote access may be offered by way of a virtual private network (VPN) connection to the local network 108.

In various implementations, a local video database (not shown) connected to the local network 108 may store and upload pre-recorded videos to content networks, such as content network 124. When a new pre-recorded video is added to the video store 120, the video catalog 116 is updated to include the new pre-recorded video information, such as title, runtime, on-air talent, etc. In various implementations, user device 1 132-1 and user device 2 132-2 can, in addition to the scheduling device 104, upload pre-recorded videos to the video store 120. In addition, content from live streaming devices 128-1 and 128-2 may be recorded for later broadcasts.

The operator interacts with the scheduling UI via the scheduling device 104 to adjust the schedule. The schedule is adjusted by adjusting timing of currently scheduled videos on the schedule and adding videos from the video catalog 116 to the schedule. The schedule stores an entry for each piece of content, including a time slot and a unique identifier of the video associated with that time slot. In various implementations, the video catalog 116 can also include identifiers that point to the live streaming device 1 128-1 and the live streaming device 2 128-2. In this way, the operator can schedule live broadcasts from the corresponding live streaming device.

After the operator edits the schedule on a display of the scheduling device 104, the scheduling system 100 can update the content network 124 with the new schedule. The content network 124 may store copies of schedules in a content network schedule store 136. The content network 124 then broadcasts videos according to the content network schedule store 136.

The content network 124 retrieves videos for broadcast from the video store 120 at the scheduled times. When the schedule stored by the content network schedule store 136 indicates that a live segment is scheduled, the content network switches from the video store 120 to a designated source of the live stream. The broadcast may be received by user devices (collectively referred to as user devices 132), such as televisions, set top boxes, streaming media players, and other electronic devices, such as a smartphone 132-1 or a laptop 132-2. In various implementations, the broadcast may be watched in a web browser or using a dedicated application. Some or all of the broadcast may be restricted to a certain audience, such as to customers of a particular brokerage, or to paying subscribers.

The broadcast content may be transmitted over the Internet 112 from the content network 124 to the user devices 132. In various implementations, the broadcast content may be distributed using one or more content delivery networks, schematically represented at 144 and 148. The content delivery networks may host or cache some or all of the video content at one or more locations that may be closer to viewers of the content than is the content network 124.

While depicted separately, the local network 108 and the Internet 112 may overlap—in other words, the local network 108 may use virtual private network (VPN) or other technology that partially or fully routes packets through the Internet 112. As an example, the scheduling device 104 may access the local network 108 via the Internet 112, such as through a VPN. In various implementations, security guidelines may restrict the scheduling device 104 from accessing the scheduling system 100 unless physically connected to a networking port on the local network 108.

Further, the content network 124 may overlap with the Internet 112. For example, the content network 124 may have multiple nodes that exchange traffic via the Internet 112. Although the video store 120 is shown in conjunction with the content network 124, the video store 120 may be hosted by the broadcaster in charge of the scheduling system 100 or by a third party. In various implementations, videos uploaded by the broadcaster in charge of the scheduling system 100 may be maintained in a local store, with copies uploaded to the video store 120. In other implementations, some videos may be broadcast from the video store 120, while others are retrieved from the local store for broadcast.

### Data Structures

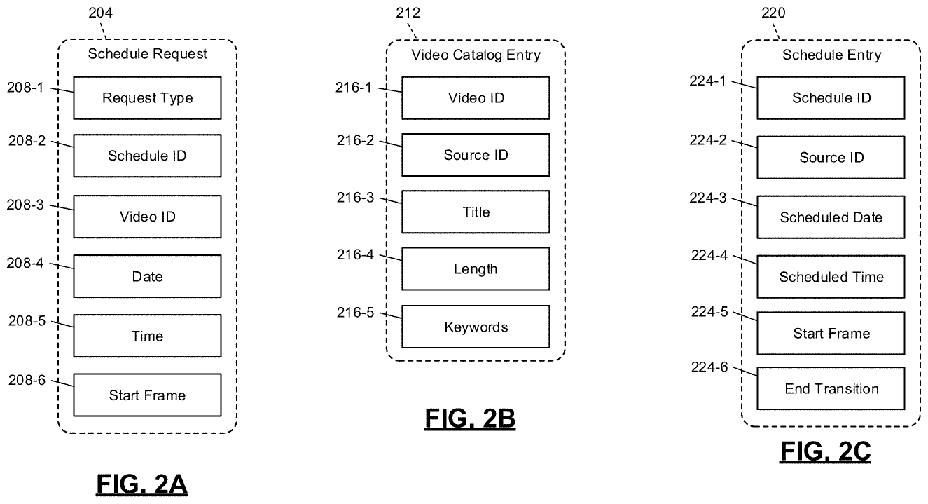

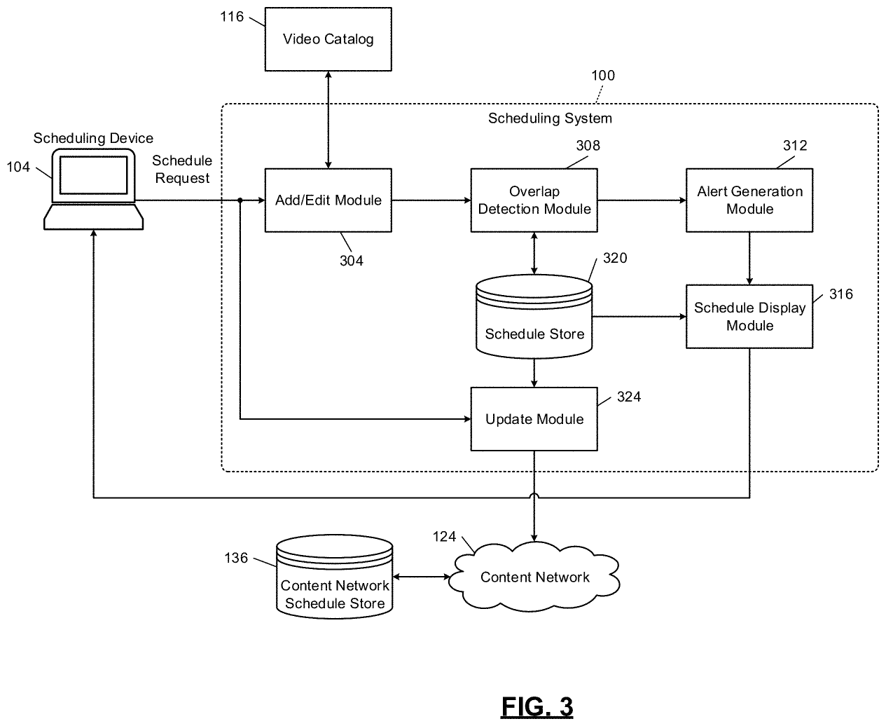

FIG. 2A shows an example data structure for a schedule request 204. The schedule request 204 may be generated by the scheduling UI in response to operator input and transmitted to the scheduling system 100 in order to add or edit a scheduled video or live stream. The schedule request 204 includes a request type 208-1 that indicates whether the schedule request is adding a pre-recorded video to the schedule, adding a live stream to the schedule, or editing an existing schedule entry. When editing (or deleting) an existing schedule entry, the schedule request 204 may specify a schedule ID 208-2 uniquely identifying the affected entry. In various implementations, the updated schedule may be transmitted to the content network 124 at periodic times or after every update. In various implementations, the updated schedule may be transmitted to the content network 124 in response to an explicit request by the operator. This request may correspond to a particular value of the request type 208-1.

The schedule request 204 includes a unique video identifier 208-3 that uniquely identifies a video stored in a video catalog, such as the video catalog 116 of FIG. 1. The video catalog 116 may include entries for a live streaming device such that the video ID 208-3 can identify a live streaming device for live broadcast. The schedule request 204 also includes a date 208-3 and a time 208-4 at which the operator would like to have the corresponding video or live stream broadcast. In various implementations, the schedule request 204 may include a specification of a start frame 208-6 of the video. The start frame 208-6 may be set to 0 or 1 (depending on the starting index of the frame) to start the video from the beginning or a different number to start playing the video partway through.

FIG. 2B is an example data structure for a video catalog entry 212 in the video catalog 116 of FIG. 1. Each entry includes information about a stored video or a live streaming device. The video catalog entry 212 includes a video identifier 216-1 that is unique within the video catalog 116. A source identifier 216-2 indicates from where a video (or live stream) of the entry is accessible. For example, when the source identifier 216-2 may indicate a video stored in the video store 120 or an identifier specifying a live streaming device.

The video catalog entry 212 may include additional metadata to assist the operator in selecting the video. For example, the video catalog entry 212 may include a title 216-3 of the video, a length 216-4 of the video, and keywords 216-5 associated with the video. In addition, metadata such as dates of the video being created, the video being edited, the video being added to the video store 120. and/or the video last being broadcast.

FIG. 2C shows an example data structure for a schedule entry 220. The schedule entry 220 includes a unique schedule ID 224-1. A source identifier 224-2 indicates the source of the scheduled video or live stream device, and may be populated based on a corresponding source ID 216-2 of a video catalog entry. In other implementations, the source ID 224-2 may instead specify a video ID 216-1 that selects the appropriate video catalog entry, from which the source ID 216-2 can be used to access the specified video or live stream.

The schedule entry 220 also includes a scheduled date 224-3 and a scheduled start time 224-4. The schedule entry 220 may record a start frame 224-5 to allow the video to be started from a frame other than the first. The schedule entry 220 may specify an end transition 224-6 to use upon conclusion of the video or immediately before switching to another video. For example, the end transition 224-6 may specify a fade to black or a horizontal wipe to a signature color of the broadcaster. In various implementations, the end transition 224-6 takes on a default setting unless specifically overridden, such as by a parameter of the schedule request 204.

### Functional Block Diagram

FIG. 3 is a functional block diagram of an example implementation of the scheduling system 100. The scheduling device 104 transmits a schedule request to the scheduling system 100. An add/edit module 304 of the scheduling system 100 receives the schedule request and identifies a corresponding video from the video catalog 116. In various implementations, the schedule request may include a request to add a selected video to the schedule. The add/edit module 304 compares a requested video identifier of the schedule request to entries of the video catalog 116 and identifies which video the schedule request is adding to the schedule. The add/edit module 304 also determines, based on the request type of the schedule request, whether the request is to edit an existing schedule entry. In various implementations, when the request is to add a new schedule entry, the scheduling device 104 may upload content (such as a pre-recorded video) to the video catalog 116.

Once the schedule request is processed and matched, an overlap detection module 308 determines whether the added or edited video will overlap with another scheduled video. The overlap detection module 308 obtains the present schedule and determines whether the requested date and the requested time of the schedule request interfere with any other scheduled video. In various implementations, if the schedule request is an edit request, the overlap detection module 308 excludes the originally scheduled video corresponding to the schedule request when comparing the requested date and time to the present schedule. In various implementations, the overlap detection module 308 obtains a runtime or a duration of each entry from the video catalog 116 to determine if an overlap of scheduled videos will occur. If the schedule request pertains to a live stream, the schedule request may include a requested runtime or duration.

An alert generation module 312 receives an overlap indication from the overlap detection module 308 indicating that the schedule request at least partially interferes with a scheduled video. In response to receiving the overlap indication, the alert generation module 312 generates an alert and transmits the alert to a schedule display module 316. In various implementations, the alert is displayed on the scheduling device 104.

In various implementations, the schedule request is canceled when the alert is transmitted. In other implementations, the schedule request is still entered into the schedule store 320. Overlap between videos may be treated according to programmable defaults. For example, consider a second video scheduled to start while a first video is still playing, creating an overlap period. In such a case, one default may be to continue playing the first video until its completion and then play the second video starting not from the beginning but from the point that occurs after the beginning by the length of the overlap period. Another default is to simply begin the second video at the scheduled time for the second video, essentially time-cropping the first video.

If no overlap is detected, the overlap detection module 308 creates an entry in a schedule store 320 based on the schedule request. The schedule display module 316 displays the schedule store 320 on the scheduling device 104, indicating when the scheduled video will be broadcast along with any other scheduled videos and live streams.

The scheduling system 100 includes an update module 324, which updates the content network schedule store 136 to reflect the entries in the schedule store 320. In various implementations, the update module 324 may perform an incremental update of the schedule store 320, transmitting only changes made since a prior update. The update may be performed based on a periodic schedule, based on when changes are made, or in response to an explicit update request, such as from the operator of the scheduling device. In various implementations, updates may be delayed to collect multiple updates over time. For example, an update may be delayed by 4 hours (or another period, such as 24 hours) so that any other update within that delay window can also be sent at the same time. This minimizes the number of network connections made between the scheduling system 100 and the content network schedule store 136.

Additionally or alternatively, the update module 324 may select scheduled entries from the schedule store 320 for a predetermined (or indefinite) period into the future and update the content network schedule store 136 with all of the selected entries. For example, once per day or once per week, the update module 324 may select a set of entries that are scheduled for the upcoming week from the schedule store 320 and provide the set of entries to the content network schedule store 136.

### User Interface

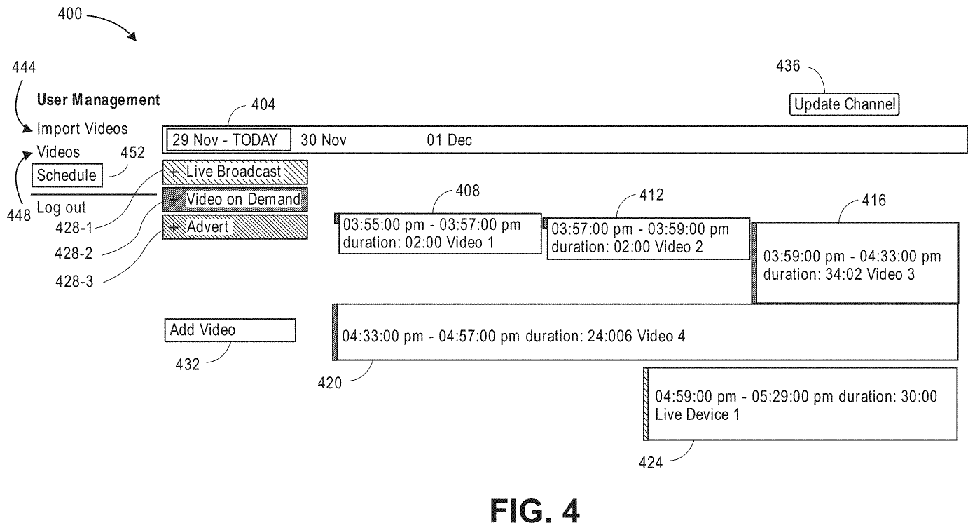

FIGS. 4-7 show representations of an example scheduling interface 400 of a scheduling system. The scheduling interface 400 includes buttons such as an imported videos button 444, a videos button 448, and a schedule button 452. In response to operator selection of the schedule button 452, the scheduling interface 400 depicts scheduled content in calendar form.

The operator may select a particular day—for example, a today indication 404 shows the current date as November 29. The scheduling interface 400 shows the videos scheduled for the selected day. For example, video 1 408 is a two-minute video scheduled to begin at 3:55 PM, video 2 412 is a two-minute video scheduled to begin at 3:57 PM, video 3 416 is a 34-minute video scheduled to begin at 3:59 PM, and video 4 420 is a 24-minute video scheduled to begin at 4:33 PM. Additionally, the scheduling interface 400 is scheduled to broadcast from live device 1 424 for a duration of 30 minutes starting at 4:59 PM.

The scheduling interface 400 identifies the source of the video or live stream using a legend including a live broadcast source 428-1, a video on demand source 428-2, and an advertisement source 428-3. The live broadcast source 428-1 may be one of the live streams, and the video-on-demand source 428-2 may be videos stored in the video database and catalogued in the video catalog. The advertisement source 428-3 may be a third-party source accessible via the Internet. To add a video or live stream to the schedule, the operator may designate a time on the schedule using, for example, a right-click, a double-click, or a tap-and-hold. An add button 432 may be selected to add the video to the scheduling interface 400. To edit a scheduled video, such as video 2 412, the operator may double-click or right-click on the scheduled video to adjust any parameters of the scheduled video.

The scheduling interface 400 also includes an update channel button 436, which may actuate the update module 324 of FIG. 3 to update the content network schedule store 136 to match what is shown in the scheduling interface 400. Once the content network schedule store 136 is up to date, any local power loss or Internet loss preventing access to or adjustment of the scheduling interface 400 will not interfere with the scheduled programs being broadcast at the scheduled times. The imported videos button 444 may include a list of operator imported videos and the videos button 448 may include a list of videos in the video catalog.

In various implementations, the scheduling interface 400 displays a countdown timer to count down to a transition time of a subsequently scheduled video broadcast. For example, if the transition is scheduled less than a predetermined time away—for example, if the transition to another scheduled video is less than one minute away—the scheduling interface 400 may display the countdown timer counting down the seconds before the subsequently scheduled video will begin being broadcast. In various implementations, a similar countdown may be displayed at a live stream location to indicate when the live stream will begin being broadcast.

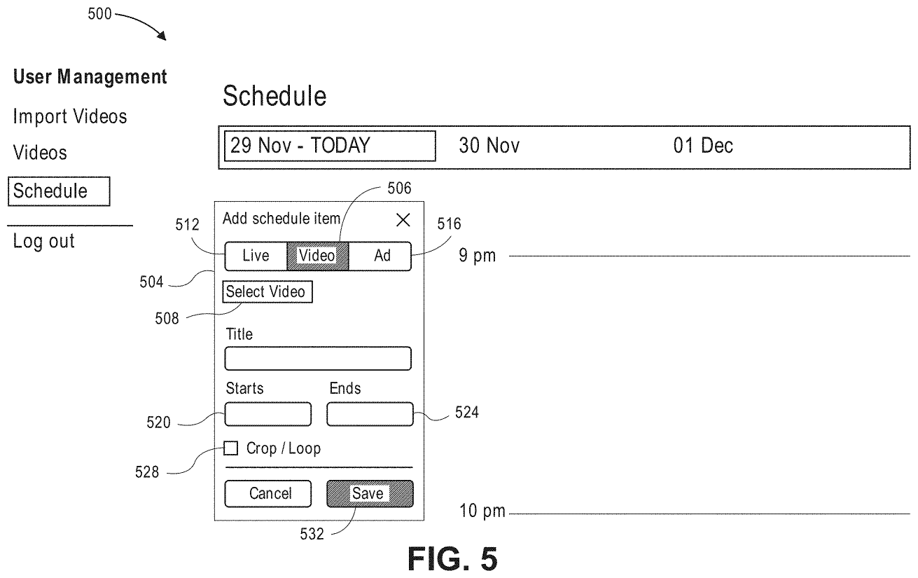

FIG. 5 shows an example scheduling interface 500 generated in response to the operator selecting the add button 432 of FIG. 4. The scheduling interface 500 includes an add dialog 504, which may, upon opening, be prepopulated based on a saved template. To add a video to the schedule, the operator chooses a video button 506. Upon user selection of the video button 506, the scheduling system displays a select video button 508.

The operator can schedule the broadcast of a live stream by selecting a live button 512 or the operator can schedule an advertisement by selecting an advertisement button 516. The add dialog 504 also includes a start time input box 520 and an end time input box 524. After the operator enters a start time into the start time input box 520, an end time is entered into the end time input box 524 automatically, and vice versa. A crop/loop selection button 528 allows the operator to determine whether to broadcast the video on a loop or shorten the length of the video. For example, when the operator selects the crop/loop selection button 528, another dialog may be displayed for the operator to select a number of loops to broadcast or select a point in time to crop the video. By selecting a save button 532, the selected video is added to the schedule.

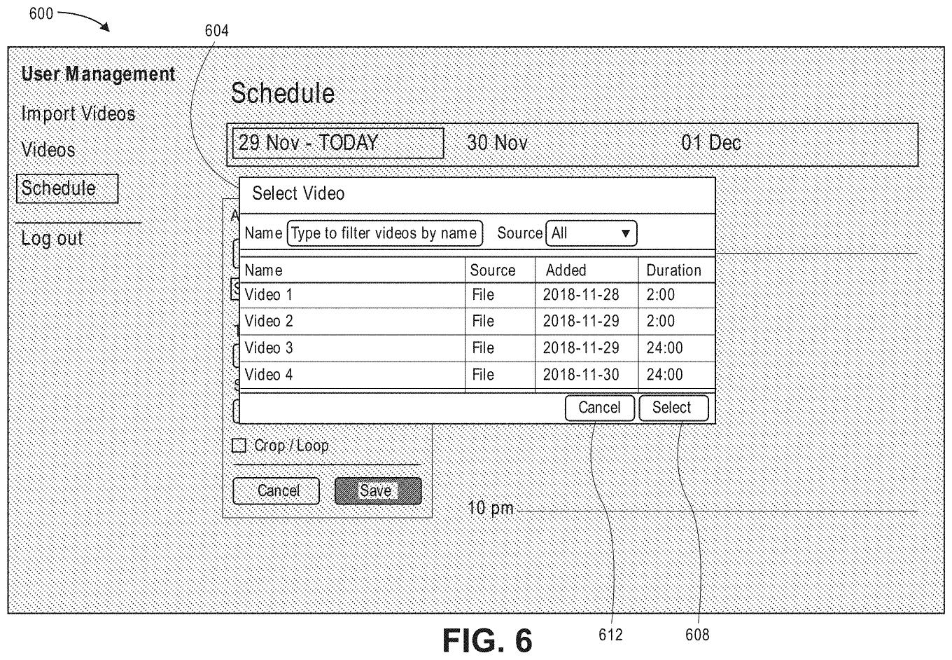

FIG. 6 is an example scheduling interface 600 shown in response to the operator actuating the select video button 508 of FIG. 5. A video selection dialog 604 lists videos included in the video catalog. Each video listed may be represented by a set of metadata, such as name/title, source, date added, and duration. In various implementations, additional fields may be shown, including: the most recent date/time the video was broadcast, the soonest (if any) future date/time at which the video is scheduled to be broadcast, the number of times the video is scheduled to be broadcast in the future, and/or the number of times the video has already been broadcast.

Once the operator selects one of the videos from the video selection dialog 604, the operator may choose a select button 608 or a cancel button 612 to add the video selection or cancel the video selection, respectively.

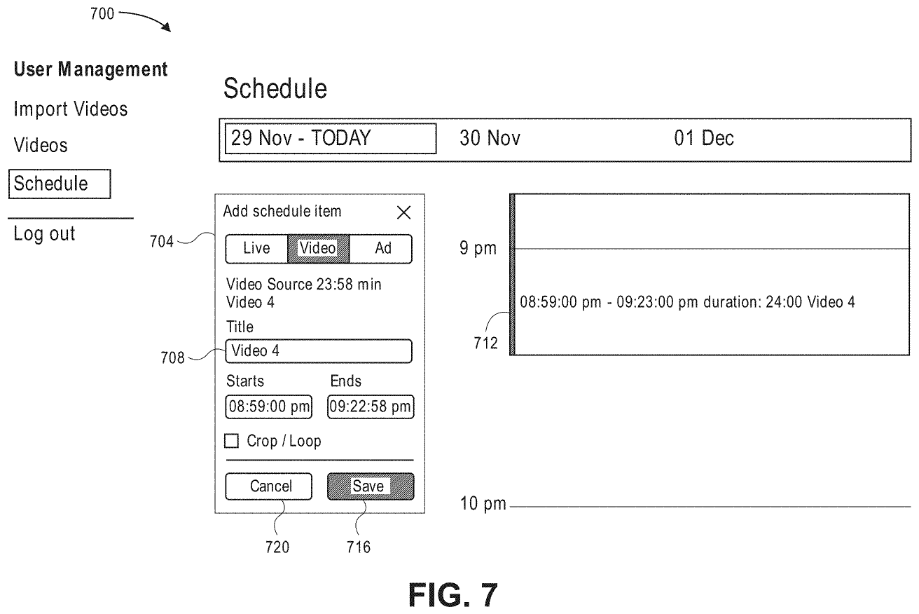

FIG. 7 shows a scheduling interface 700 presented following selection of a video. An add dialog 704 (which may be the same as the add dialog 504 of FIG. 5) displays a title 708 of the selected video as well as a duration. The scheduling interface 700 also displays a scheduled video indicator 712 of the selected video within the calendar view. Upon specifying either the start or the end time for the video, the other field may be automatically updated based on the duration of the video. If the crop/loop checkbox is marked, the start and end times may no longer need to be tied to the video duration. Setting start and end times that are closer to each other than the length of the video means the video will be cropped. Meanwhile, setting start and end times that are further away from each other than the length of the video means the video will be looped to fill the time slot.

In various implementations (not shown), the end of the video may be cropped, such as by setting an end number indicating at which frame the video will end. In various implementations, there may be 30 frames per second, so setting the value to 3600 may end the video approximately 120 seconds (two minutes) early. Additionally or alternatively, the beginning of a video may also be cropped. In various implementations (not shown), a transition (such as fade to black) can be associated with the video. The transition may be actuated at the conclusion of the video. Or, in an implementation where a second video may be permitted to start before the first is finished, the transition may begin just prior to the beginning of the second video even though the first video is not concluded.

If the operator selects a save button 716, the scheduled video indicator 712 is added as an entry to the schedule. Either immediately or after a delay, this entry will be transmitted to the content network schedule store 136 for broadcast. If the operator selects a cancel button 720 in the add dialog 704, the scheduled video indicator 712 is removed from the scheduling interface 700 and if an entry had been speculatively created in the schedule, the entry may be deleted.

### Flowcharts

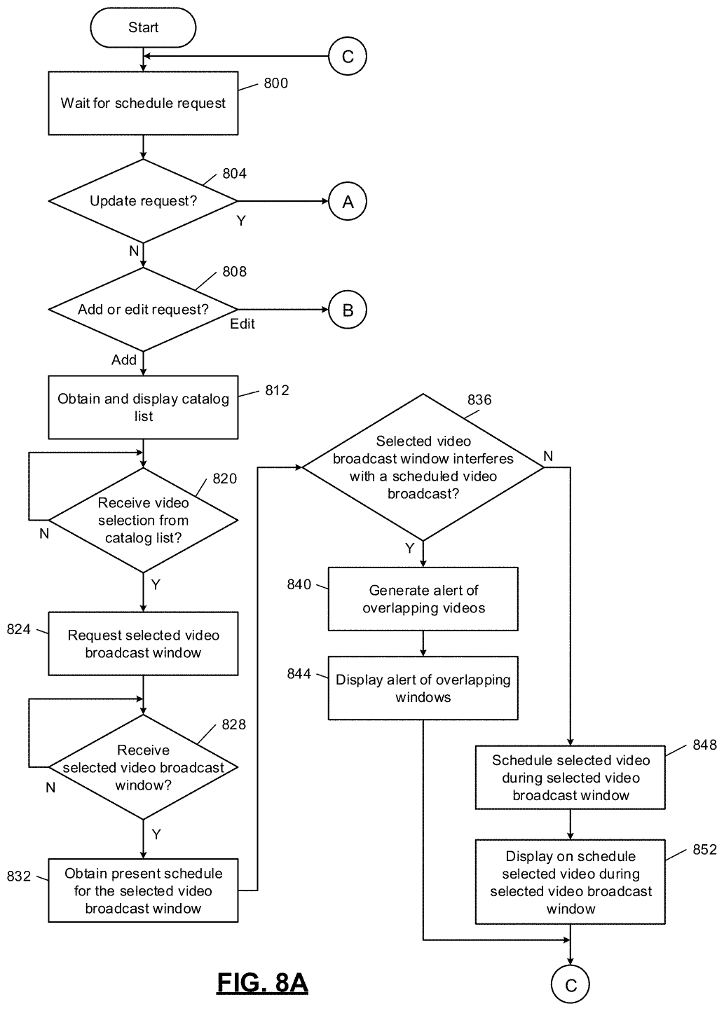

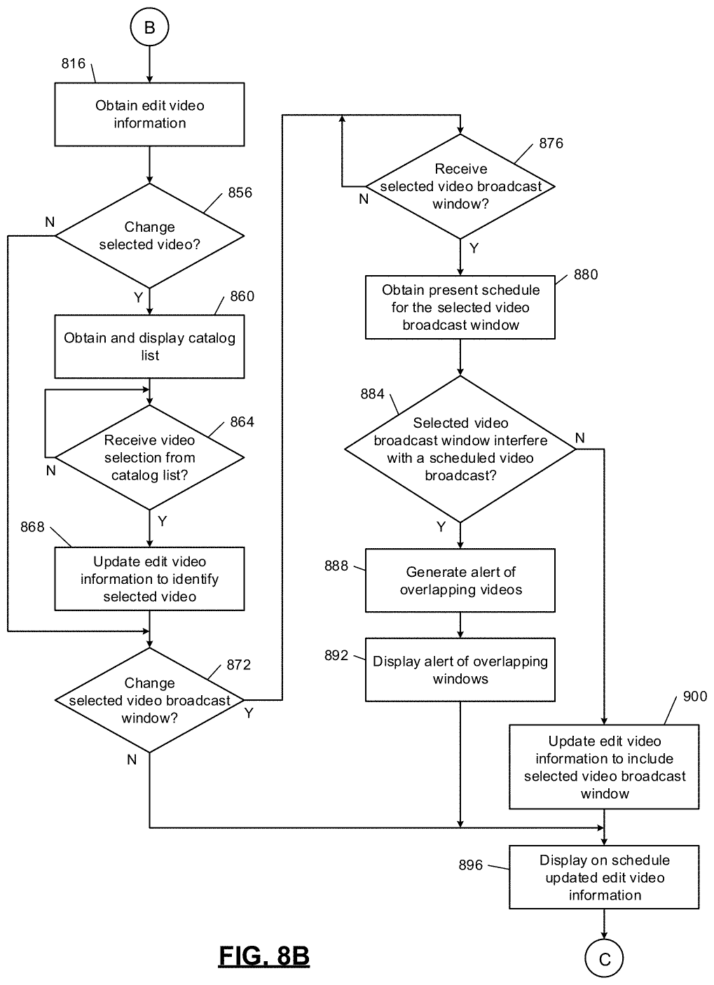

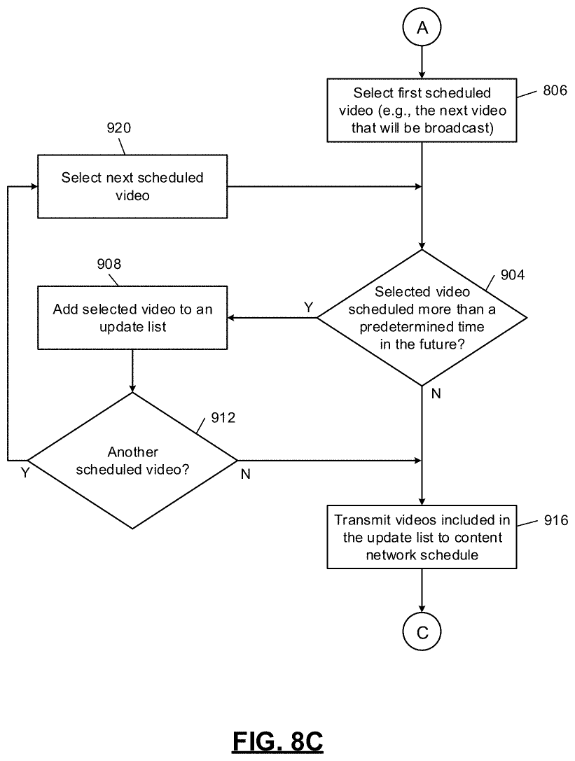

FIGS. 8A-8C are flowcharts depicting example processing of a schedule request within a scheduling system. Control begins at 800, where control waits for a schedule request. Control continues to 804 to determine if the schedule request includes an update request. If yes, control continues to 806 of FIG. 8C. Otherwise, control continues to 808 where control determines if the schedule request includes an add request or an edit request. If the schedule request includes an add request, control continues to 812. If the schedule request includes an edit request, control continues to 816 of FIG. 8B.

At 812, control obtains and displays a catalog list. The catalog list may include all pre-recorded videos available in a video database for broadcast. The catalog list may also include selectable live streaming devices to display live broadcasts from the live streaming devices. Control continues to 820 to determine if a video selection from the catalog list has been received. If not, control waits for the video selection to be received. Once a video selection is received, control continues to 824. At 824, control requests a selected video broadcast window for example, control prompts the operator via a user interface (such as a user interface of FIGS. 4-7) to determine the selected video broadcast window. In various implementations, the operator may input a start time of the selected video and, based on a duration of the selected video, an end time of the video may then be determined.

Control continues to 828 to determine whether the selected video broadcast window has been received. If not, control waits for the selected video broadcast window to be received. Control then continues to 832 where control obtains a present schedule for the selected video broadcast window. At 836, control determines if the selected video broadcast window interferes with a scheduled video included in the present schedule. If yes, control continues to 840 to generate an alert of overlapping videos. Control then continues to 844 to display the alert of overlapping windows on the user interface. Returning to 836, if control determines that the selected video broadcast window does not interfere with an already scheduled video, control continues to 848. At 848, control schedules the selected video during the selected video broadcast window by generating a schedule entry based on the schedule request. Control continues at 852. At 852, control displays the schedule entry in the calendar view. Control then returns to 800 to wait for another schedule request.

Returning to 816 of FIG. 8B, control obtains edit video information included in the schedule request. The edit video information includes the selected video to edit, and may include a scheduled time of the selected video. Control continues at 856. At 856, control determines if the schedule request is changing the selected video being broadcast. If the edit video information does not indicate that the selected video is being changed, control continues to 872. If the edit video information changes the selected video, control continues to 860 to obtain and display the catalog list for the operator to select a different video for broadcast. Control continues to 864 to receive the video selection from the catalog list. At 864, control waits for the operator to select a video from the catalog list. Control receives an indication of the selected video and continues to 868. At 868, control updates the edit video information to identify the newly selected video and continues to 872.

At 872, control determines if a change to the selected video broadcast window is indicated. If control determines that the selected video broadcast window is not being changed, control continues to 896 to display the updated edit video information in the calendar view. If control determines that the selected video broadcast window is being changed, control continues to 876 to receive the selected video broadcast window. Control then continues to 880 to obtain a present schedule for the selected video broadcast window. Control then continues to 884. At 884, control determines if the selected video broadcast window interferes with a scheduled video broadcast of the present schedule. If yes, control continues to 888, where an alert is generated indicating overlapping videos. Control then continues to 892 to display the alert of overlapping windows. Control continues to 896 to display any updated edit video information on the schedule. Control then returns to 800 to wait for another schedule request.

Returning to 884, if control determines that the selected video broadcast window does not interfere with a scheduled video broadcast, control continues to 900. At 900, control updates the edit video information to include the selected video broadcast window in the edit video information. Control then continues to 896 to display the updated edit video information in the calendar view. Control then returns to 800 to wait for another schedule request.

Returning to 804, if control determines that the schedule request includes an update request, control continues to 806 of FIG. 8C. At 806, control selects a first scheduled video, which may be the next video to be broadcast. In various implementations, control may select scheduled videos in chronological order from the present date/time forward. Control then continues to 904 to determine if the selected video is scheduled to be broadcast over a predetermined time in the future—for example, control determines if the selected video is scheduled during the following week or scheduled for more than one week away. If the selected video is within the predetermined time in the future, control continues to 908 to add the selected video to an update list. The content network schedule will be updated with any scheduled broadcasts for the predetermined time in the future. The update list includes each scheduled video for the predetermined time in the future. Control then continues to 912 to determine if another video is scheduled.

At 912, if another video is not scheduled, control continues to 916 to transmit the selected videos included from the update list to the content network schedule store 136. After updating the content network schedule store 136, control returns to 800 to wait to receive another schedule request. At 912, if control determines that there is another scheduled video, control continues to 920 to select the next scheduled video. Control then returns to 904 to determine if the selected video is within the predetermined time in the future (for example, within the current week).

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A video content sequencing system comprising:
at least one processor; and
a memory coupled to the at least one processor,
wherein the memory stores:
a video catalog including a plurality of entries, wherein each entry of the plurality of entries includes: (i) a video identifier and (ii) a source identifier, wherein the source identifier for each entry of the plurality of entries identifies at least one of: (i) a video database and (ii) a live stream device;
a schedule including a plurality of scheduled video identifiers each of the plurality of scheduled video identifiers corresponding to a respective video identifier of a respective entry of the plurality of entries; and
instructions that, upon execution, cause the at least one processor to:
in response to input from an operator, identify a first video identifier of a first entry of the video catalog that corresponds to a requested video identifier of a schedule request, wherein the input includes the schedule request, and wherein the schedule request includes: (i) a request type, (ii) the requested video identifier, (iii) a requested date, and (iv) a requested time; and
schedule a first video associated with the first video identifier to be automatically displayed from a first source identifier associated with the first video identifier on a channel by adding the first video identifier to the schedule at the requested time on the requested date included in the schedule request.

2. The system of claim 1 wherein:
the video database stores a plurality of pre-recorded videos, wherein each pre-recorded video is associated with a pre-recorded video identifier, and wherein the plurality of entries of the video catalog include a corresponding entry for each pre-recorded video identifier.

3. The system of claim 1 wherein:
the plurality of entries of the video catalog are displayed to the operator on a display of a scheduling device, wherein the input from the operator is a selection of the first video identifier.

4. The system of claim 1 wherein the instructions, upon execution, cause the at least one processor to:
in response to the first source identifier identifying the live stream device, schedule the live stream device to be broadcast on the channel at the requested time on the requested date included in the schedule request by adding a live stream device identifier to the schedule.

5. The system of claim 1 wherein the instructions, upon execution, cause the at least one processor to schedule the first video by:
generating a first scheduled video entry including: (i) a first scheduled video identifier, (ii) a first scheduled source identifier, (iii) a first scheduled date, and (iv) a first scheduled time to add to the schedule.

6. The system of claim 5 wherein:
the first scheduled video identifier is set to the first video identifier of the first entry of the video catalog,
the first scheduled source identifier is set to the first source identifier of the first entry of the video catalog,
the first scheduled date is set to the requested date of the scheduled request, and
the first scheduled time is set to the requested time of the scheduled request.

7. The system of claim 1 wherein the instructions, upon execution, cause the at least one processor to, in response to scheduling the first video:
identify a previously scheduled video identifier of the schedule during a broadcast window of the first video identifier,
in response to identifying the previously scheduled video identifier, generate an overlapping alert, and
display the overlapping alert on a display of a scheduling device.

8. The system of claim 1 wherein instructions, upon execution, cause the processor to:
in response to the request type of the schedule request being an update schedule request, transmit a set of scheduled video identifiers to a content network schedule of a content network.

9. The system of claim 8 wherein instructions, upon execution, cause the at least one processor to transmit the set of scheduled video identifiers by:
selecting scheduled video identifiers scheduled to be broadcast between a present date and a present time and a cutoff date and a cutoff time,
adding the selected scheduled video identifiers to the set of scheduled video identifiers, and
transmitting the set of scheduled video identifiers to the content network schedule of the content network.

10. The system of claim 8 wherein the set of scheduled video identifiers instructs the content network to transition to broadcast on the channel a scheduled video corresponding to a scheduled video identifier of the plurality of scheduled video identifiers on the content network schedule at a scheduled time on a scheduled date of the scheduled video.

11. A video content sequencing method comprising:
in response to input from an operator, identifying a first video identifier of a first entry of a video catalog that corresponds to a requested video identifier of a schedule request, wherein:
the input includes the schedule request,
the schedule request includes: (i) a request type, (ii) the requested video identifier, (iii) a requested date, and (iv) a requested time,
the video catalog includes a plurality of entries,
each entry of the plurality of entries includes: (i) a video identifier and (ii) a source identifier, and
the source identifier for each entry of the plurality of entries identifies at least one of: (i) a video database and (ii) a live stream device; and
scheduling a first video associated with the first video identifier to be automatically displayed from a first source identifier associated with the first video identifier on a channel by adding the first video identifier to a schedule at the requested time on the requested date included in the schedule request,
wherein the schedule includes a plurality of scheduled video identifiers each of the plurality of scheduled video identifiers corresponding to a respective video identifier of a respective entry of the plurality of entries.

12. The method of claim 11 wherein:
the video database stores a plurality of pre-recorded videos, wherein each pre-recorded video is associated with a pre-recorded video identifier, and wherein the plurality of entries of the video catalog include a corresponding entry for each pre-recorded video identifier.

13. The method of claim 11 wherein:
the plurality of entries of the video catalog are displayed to the operator on a display of a scheduling device, wherein the input from the operator is a selection of the first video identifier.

14. The method of claim 11 further comprising, in response to the first source identifier identifying the live stream device, scheduling the live stream device to be broadcast on the channel at the requested time on the requested date included in the schedule request by adding a live stream device identifier to the schedule.

15. The method of claim 11 wherein scheduling the first video includes:
generating a first scheduled video entry including: (i) a first scheduled video identifier, (ii) a first scheduled source identifier, (iii) a first scheduled date, and (iv) a first scheduled time to add to the schedule.

16. The method of claim 15 wherein:
the first scheduled video identifier is set to the first video identifier of the first entry of the video catalog,
the first scheduled source identifier is set to the first source identifier of the first entry of the video catalog,
the first scheduled date is set to the requested date of the scheduled request, and
the first scheduled time is set to the requested time of the scheduled request.

17. The method of claim 11 further comprising, in response to scheduling the first video:
identifying a previously scheduled video identifier of the schedule during a broadcast window of the first video identifier,
in response to identifying the previously scheduled video identifier, generating an overlapping alert, and
displaying the overlapping alert on a display of a scheduling device.

18. The method of claim 11 further comprising:
in response to the request type of the schedule request being an update schedule request, transmitting a set of scheduled video identifiers to a content network schedule of a content network.

19. The method of claim 18 wherein transmitting the set of scheduled video identifiers includes:
selecting scheduled video identifiers scheduled to be broadcast between a present date and a present time and a cutoff date and a cutoff time,
adding the selected scheduled video identifiers to the set of scheduled video identifiers, and
transmitting the set of scheduled video identifiers to the content network schedule of the content network.

20. The method of claim 18 wherein the set of scheduled video identifiers instructs the content network to transition to broadcast on the channel a scheduled video corresponding to a scheduled video identifier of the plurality of scheduled video identifiers on the content network schedule at a scheduled time on a scheduled date of the scheduled video.
